(19) United States
(12) Patent Application Publication
(10) Pub. No.: US 2007/0008468 A1
(43) Pub. Date: Jan. 11, 2007

(54) Liquid crystal display panel and liquid crystal display device using the same

(75) Inventors: Yuan Li, Shenzhen (CN); Yu-Hsun Jen, Miao-Li (TW); Ming-Bo Tai, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/483,710

(22) Filed: Jul. 10, 2006

(30) Foreign Application Priority Data
Jul. 8, 2005 (TW) 94211605

(51) Int. Cl. G02F 1/1335

(52) U.S. Cl. 349/114

(57) ABSTRACT

An exemplary liquid crystal display panel (20) includes a first substrate (22), a second substrate (21) opposite to the first substrate, a liquid crystal layer (23) between the first and second substrates, an electrode layer (24) between the liquid crystal layer and the second substrate. The electrode layer includes a plurality of reflection portions (241) and transmission portions (242). A color filter (25) is disposed between the electrode layer and the second substrate. When the liquid crystal display panel is used in a reflection mode, ambient light beams need not pass through the color filter. This decreases the loss of light beams and increases the efficiency of utilization of light beams. Moreover, in the reflection mode, images are displayed in black and white, which can improve visibility, especially in an environment of strong ambient light.

### FIELD OF THE INVENTION

The present invention relates to liquid crystal display (LCD) panels and liquid crystal display devices using LCD panels, and more particularly to a reflection/transmission type LCD device capable of providing a display both in a reflection mode and a transmission mode.

### GENERAL BACKGROUND

Among LCD products, there have been the following three types of LCD devices commercially available: a reflection type LCD device utilizing ambient light, a transmission type LCD device utilizing backlight, and a semi-transmission type LCD device equipped with a half mirror and a backlight. With a reflection type LCD device, a display becomes less visible in a poorly lit environment. In contrast, a display of a transmission type LCD device appears hazy in strong ambient light (e.g., outdoor sunlight). Thus researchers sought to provide an LCD device capable of functioning in both modes so as to yield a satisfactory display in any environment. In due course, a reflection/transmission type LCD device was developed.

Part of an LCD panel of a typical reflection/transmission type LCD device is shown in FIG. 5. The LCD panel 10 includes a top polarizer 1, a first phase shift layer 2, a second phase shift layer 3, a top substrate 4, a color filter 5, a first electrode layer 6, a top alignment layer 7, a liquid crystal layer 8, a bottom alignment layer 17, a second electrode layer 16, a bottom substrate 14, and a bottom polarizer 11, disposed in that order from top to bottom.

The second electrode layer 16 includes a plurality of reflection portions 161 and a plurality of transmission portions 162 which are alternately arranged. The reflection portions 161 are made of highly reflective material, and the transmission portions 162 are made of transparent material.

In use, when the ambient light is strong enough, the liquid crystal display panel 10 is used in a reflection mode. Ambient light beams above the liquid crystal display panel 10 pass through the top polarizer 1, the color filter 5, and the liquid crystal layer 8 and irradiate the reflection portions 161. The ambient light beams are reflected by the reflection portions 161, and pass back through the color filter 5 and the top substrate 4 to display images.

When the ambient light is poor, the LCD panel 10 is used in a transmission mode. Light beams emitted by a backlight (not shown) below the liquid crystal display panel 10 pass through the transmission portions 162, the liquid crystal layer 8, the color filter 5, and the top substrate 4 to display images.

However, light beams pass through the color filter 5 twice in the reflection mode, but only once in the transmission mode. This causes the color saturation of displayed images to be different in the two modes. Moreover, when light beams pass through the color filter 5 twice in the reflection mode, some of the light beams are absorbed, and the quality of the displayed images is reduced.

What is needed, therefore, is a liquid crystal display panel and a liquid crystal display device that overcome the above-described deficiencies.

### SUMMARY

An exemplary liquid crystal display panel includes a first substrate, a second substrate opposite to the first substrate, a liquid crystal layer between the first and second substrates, and an electrode layer between the liquid crystal layer and the second substrate. The electrode layer includes a plurality of reflection portions and a plurality of transmission portions. A color filter is disposed between the electrode layer and the second substrate.

An exemplary liquid crystal display device includes a liquid crystal display panel and a backlight module. The liquid crystal display panel includes a first substrate, a second substrate opposite to the first substrate, a liquid crystal layer between the first and second substrates, and an electrode layer between the liquid crystal layer and the second substrate. The first electrode layer includes a plurality of reflection portions and transmission portions. A color filter is disposed between the electrode layer and the second substrate. The backlight module is disposed adjacent to the second substrate.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of part of a liquid crystal display panel according to a first embodiment of the present invention.

FIG. 2 is a side cross-sectional view of part of a liquid crystal display panel according to a second embodiment of the present invention.

FIG. 3 is a side cross-sectional view of part of a liquid crystal display panel according to a third embodiment of the present invention.

FIG. 4 is a side cross-sectional view of part of an LCD device of an exemplary embodiment of the present invention, the LCD device including the liquid crystal display panel of FIG. 1.

FIG. 5 is a side cross-sectional view of part of a conventional liquid crystal display panel.

### DETAILED DESCRIPTION OF PREFERRED EMBODIMENTS

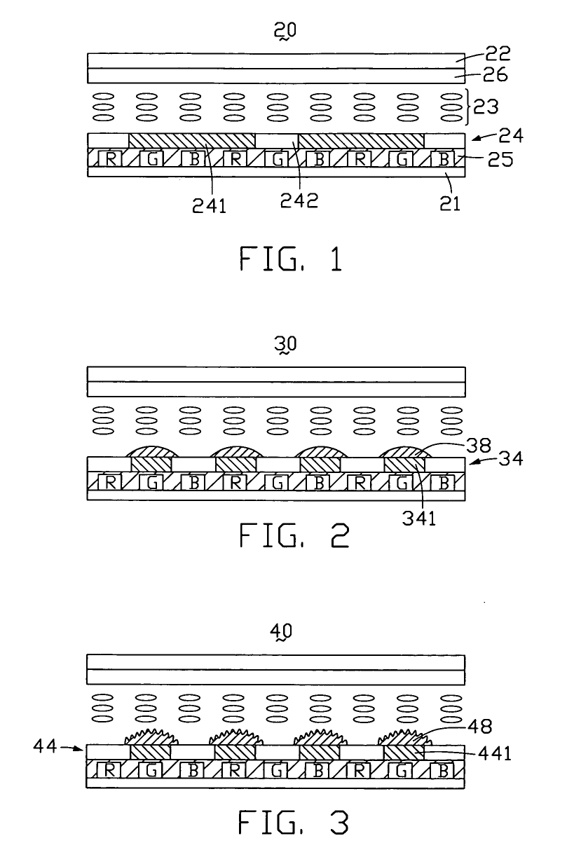

FIG. 1 is a schematic, side cross-sectional view of part of a liquid crystal display panel according to a first embodiment of the present invention. The liquid crystal display panel 20 includes a top glass substrate 22, a first electrode layer 26, a liquid crystal layer 23, a second electrode layer 24, a color filter 25, and a bottom glass substrate 21, disposed in that order from top to bottom.

The second electrode layer 24 includes a multiplicity of reflection portions 241 and a multiplicity of transmission portions 242, which are alternately arranged. The reflection portions 241 are made of highly reflective material, such as aluminum, aluminum alloy, or a like material. The transmission portions 242 are made of transparent material, such as indium-tin-oxide (ITO) or indium-zinc-oxide (IZO). The first electrode layer 26 is made of transparent material.

In use, when ambient light is strong enough, the liquid crystal display panel 20 is used in a reflection mode. Ambient light beams above the liquid crystal display panel 20 pass through the top substrate 22 and the first electrode layer 26, and irradiate the reflection portions 241. The ambient light beams are reflected by the reflection portions 241, and pass back through the first electrode layer 26 and the top substrate 22 to display images.

When the ambient light is poor, the liquid crystal display panel 20 is used in a transmission mode. Light beams emitted by a backlight (not shown) pass through the color filter 25, the transmission portions 242 and the liquid crystal layer 23, and then transmit out of the top substrate 22 to display images.

The color filter 25 is arranged between the second electrode layer 24 and the bottom substrate 21. The color filter 25 includes a multiplicity of red (R), green (G) and blue (B) portions which are alternately arranged, and a transparent overcoat layer covering and filling gaps between the red, green and blue portions. When the liquid crystal display panel 20 is used in the reflection mode, ambient light beams need not pass through the color filter 25. This decreases the loss of light beams and increases the efficiency of utilization of light beams. Moreover, in the reflection mode, images are display in black and white. This can improve visibility, especially in an environment of strong ambient light.

FIG. 2 is a schematic, side cross-sectional view of part of a liquid crystal display panel according to a second embodiment of the present invention. The liquid crystal display panel 30 is similar to the liquid crystal display panel 20 of the first embodiment. However, the liquid crystal display panel 30 further includes a multiplicity of reflectors 38 arranged on reflection portions 341 of a second electrode layer 34. A top surface of each of the reflectors 38 is spherical.

FIG. 3 is a schematic, side cross-sectional view of part of a liquid crystal display panel according to a third embodiment of the present invention. The liquid crystal display panel 40 is similar to the liquid crystal display panel 30 of the second embodiment. However, the liquid crystal display panel 40 includes a multiplicity of reflectors 48 arranged on reflection portions 441 of a second electrode layer 44. Each of the reflectors 48 is generally dome-shaped, but has a plurality of bumps on a top surface thereof.

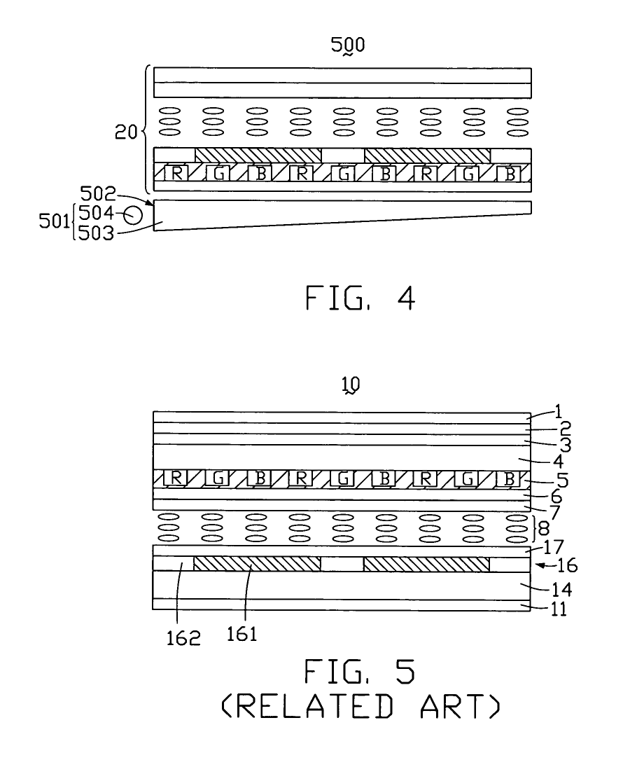

FIG. 4 is a schematic, side cross-sectional view of part of an LCD device of an exemplary embodiment of the present invention. The LCD device 500 includes the liquid crystal display panel 20 of the first embodiment, and a backlight module 501 positioned below the liquid crystal display panel 20. The backlight module 501 includes a wedge light guide plate 503, and a light source 504. The light guide plate 503 is disposed adjacent to a bottom side of the liquid crystal display panel 20. The light guide plate 503 includes a side incident surface 502, and the light source 504 is arranged adjacent to the incident surface 502. Light beams emitted by the light source 504 are used for illuminating the liquid crystal display panel 20 in the transmission mode.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display panel, comprising:
a first substrate;
a second substrate opposite to the first substrate;
a liquid crystal layer between the first and second substrates;
an electrode layer between the liquid crystal layer and the second substrate, the electrode layer defining a plurality of reflection portions and a plurality of transmission portions; and
a color filter between the electrode layer and the second substrate.

2. The liquid crystal display panel as claimed in claim 1, further comprising a plurality of reflectors arranged on the reflection portions.

3. The liquid crystal display panel as claimed in claim 2, wherein a surface of each of the reflectors is spherical.

4. The liquid crystal display panel as claimed in claim 2, wherein each of the reflectors comprises a plurality of bumps.

5. A liquid crystal display device, comprising:
a liquid crystal display panel, comprising:
a first substrate;
a second substrate opposite to the first substrate;
a liquid crystal layer between the first and second substrates; an electrode layer between the liquid crystal layer and the second substrate, the electrode layer defining a plurality of reflection portions and a plurality of transmission portions; and
a color filter between the electrode layer and the second substrate; and
a backlight module adjacent to the second substrate.

6. The liquid crystal display device as claimed in claim 5, further comprising a plurality of reflectors arranged on the reflection portions.

7. The liquid crystal display device as claimed in claim 6, wherein a surface of each of the reflectors is spherical.

8. The liquid crystal display device as claimed in claim 6, wherein each of the reflectors comprises a plurality of bumps.

9. The liquid crystal display device as claimed in claim 5, wherein the backlight module comprises a light guide plate and a light source.

10. The liquid crystal display device as claimed in claim 9, wherein light guide plate comprises an incident surface.

11. The liquid crystal display device as claimed in claim 10, wherein the light source is disposed adjacent to the incident surface of the light guide plate.

12. A liquid crystal display panel, comprising:
a liquid crystal layer;
a light guide plate disposed opposite to the liquid crystal layer;
an electrode layer between the liquid crystal layer and the light guide plate, the electrode layer defining a plurality of reflection portions and a plurality of transmission portions; and
a color filter between the electrode layer and the light guide plate.
